(19) United States
(12) Patent Application Publication
(10) Pub. No.: US 2024/0039013 A1
(43) Pub. Date: Feb. 1, 2024

(54) LONG-LIFE MEMBRANE ELECTRODE SEALING STRUCTURE FOR FUEL CELLS

(71) Applicant: Cemt Co., Ltd., Jiaxing City (CN)

(72) Inventors: Liming XU, Jiaxing City (CN); Dong LIU, Jiaxing City (CN); Zhuolong CAI, Jiaxing City (CN)

(21) Appl. No.: 18/261,824

(22) PCT Filed: Dec. 13, 2021
(86) PCT No.: PCT/CN2021/137476

§ 371 Date: Jul. 17, 2023

(30) Foreign Application Priority Data
Jul. 30, 2021 (CN) 202110867620.5

(51) Int. Cl. H01M 8/0276

(52) U.S. Cl. CPC H01M 8/0276

(57) ABSTRACT

A long-life sealing structure of a membrane electrode for fuel cells includes an anode plate and a cathode plate, which are stacked together and sandwich a proton exchange membrane and two diffusion sheets between them. Both ends of the anode plate and the cathode plate are provided with through-holes. The outer surface of the anode plate is provided with a sealing groove assembly including a first ring groove, a strip groove and a second annular groove. The first ring groove is embedded with a sealing ring. The interior of the strip groove is stepped, with guide grooves on both sides extending outward to the surface of the anode plate; the strip groove is embedded with a sealing strip with its outer surface fitted with a cover. The adsorption-type sealing mechanism provides targeted sealing for the connection between the membrane electrode and the catalytic sheet, enhances the sealing performance.

### TECHNICAL FIELD

The present invention relates to the field of fuel cell technology, specifically to the sealing structure of a long-life membrane electrode for a fuel cell.

### BACKGROUND

Fuel cell is a chemical device that directly converts the chemical energy of fuel into electrical energy, which is also known as an electrochemical generator. The membrane electrode is assembled between two bipolar plates and is used for proton conversion and power generation. The membrane electrode contains gas and water, so its sealing is crucial.

Chinese invention patent application number CN200510023723.4 discloses a sealing structure for a flow-guiding bipolar plate or membrane electrode used in a fuel cell. The seal structure includes a flow-guiding bipolar plate or a membrane electrode assembly and a sealing member. The sealing member is symmetrically arranged on the positive and negative sides of the flow-guiding bipolar plate or the membrane electrode assembly. Multiple connecting through-holes are opened at the position where the sealing member is installed on the flow-guiding bipolar plate or the membrane electrode assembly. The two sealing members on the positive and negative sides of the flow-guiding bipolar plate or the membrane electrode assembly are connected together through the aforementioned multiple connecting through-holes using the same material as themselves. Compared with the prior art, the sealing structure of the present invention is not easily deformed and will not fall off when the flow-guiding bipolar plate and the membrane electrode assembly are separated, and can be reused.

However, this sealing method has some problems.

First, the sealing element is installed on the positive and negative sides of the membrane electrode, which can provide basic sealing for the membrane electrode. However, to improve the conversion efficiency of the membrane electrode, catalytic sheets are attached to both sides of the membrane electrode to accelerate the catalysis. The lack of sealing between the catalytic sheet and the membrane electrode can easily cause gas to enter the gap between them, resulting in gas bypassing the catalytic sheet and directly reacting with the membrane electrode assembly, without undergoing catalytic reaction, resulting in decrease in ion conversion rate without passing through the catalytic reaction.

Second, the sealing element is installed on the positive and negative sides of the membrane electrode, which can provide basic sealing for the membrane electrode. However, the sealing ring is in contact with water and oxygen for a long time, which can cause corrosion and affect its lifespan.

Third, the sealing at the connection between the membrane electrode and the catalytic sheet cannot be targeted. When used in new energy vehicles, during acceleration or sudden stops, the internal gas and liquid will be affected by inertia and will accelerate the impact on the connection between the membrane electrode and the catalytic sheet. Over time, this will cause a rapid decrease in sealing performance.

Therefore, it is necessary to design a sealing structure for a long-life membrane electrode for fuel cells to solve the above problems.

### SUMMARY

The purpose of the present invention is to provide a seal structure for a long-life membrane electrode assembly for fuel cells, in order to solve the problems of short seal life and rapid decline in sealing performance at the connection between the membrane electrode assembly and the catalytic sheet when used in vehicles in accelerating state, as raised in the background technology.

To achieve the above objectives, the present invention provides the following technical solution: a long-life membrane electrode sealing structure for fuel cells, including an anode plate and a cathode plate. The anode plate and cathode plate are stacked together and sandwich a proton exchange membrane and diffusion sheets between them. The diffusion sheets consist of two pieces and are distributed on both sides of the proton exchange membrane; the two ends of the anode plate and cathode plate are both provided with through holes, and the outer surface of the anode plate is provided with a sealing groove assembly; the sealing groove assembly includes a first annular groove, a strip groove, and a second annular groove; the first annular groove is embedded with a sealing ring, and the interior of the strip groove is stepped; both sides of the strip groove are provided with guide grooves that extend outward to the surface of the anode plate; the strip groove is embedded with a sealing strip, and the outer surface of the sealing strip is fitted with a cover; the cover is embedded in the strip groove; the second annular groove is embedded with an edging ring, and the edging ring surrounds the sealing ring; the two ends of the sealing strip are raised and the middle is depressed, and the center of the sealing strip is integrally connected with a cambered convex strip.

Preferably, the sealing ring is annular and surrounds the inside of the anode plate in a circle, and the two ends of the sealing ring are set around the outside of the through holes.

Preferably, the number of sealing rings and sealing strips is two, and the two sealing rings and two sealing strips are respectively installed on the anode plate and cathode plate.

Preferably, the edging ring includes a ring body and an inflation hole. The edge of the ring body is arc-shaped, and the surface of the ring body is provided with an inflation hole.

Preferably, the inflation hole is composed of two trumpet-shaped through-holes combined together, and a right trumpet-shaped through-hole is fitted on a tail end of a left trumpet-shaped through-hole.

Preferably, the proton exchange membrane includes a membrane electrode; both sides of the membrane electrode are adhered with catalytic sheets, and the outer periphery of the catalytic sheets is wrapped with a sealing film, which is fixed to the catalytic sheets by an adhesive.

Compared with the prior art, the beneficial effect of the present invention is that the present invention has an independent adsorption-type sealing mechanism, which provides targeted sealing for the connection between the membrane electrode and the catalytic sheet, enhances the sealing performance, and prolongs the sealing life.

(1) By opening a strip groove on the surface of the anode plate and embedding a sealing strip with raised ends and a depressed middle, and fixing a cambered convex strip at the center of the sealing strip, after the anode plate and cathode plate are stacked, the sealing strip is sandwiched at the connection between the catalytic sheet and the sealing film. When the anode plate and cathode plate are compressed, the cambered convex strip at the center of the sealing strip deforms and expands to both sides, causing the ends of the sealing strip to lift and the gas in the concave groove on the surface of the sealing strip to be discharged. This causes the sealing strip to adhere to the surface of the catalytic sheet and sealing film, and the sloping surfaces on both sides of the sealing strip can cushion the impact of liquid. During long-term use in high-speed vehicles, the sealing stability can be ensured.

(2) By surrounding the sealing ring with an edging ring on the outside, the edge of the ring body is bent inward to form a cavity between the edging ring and the sealing ring. Nitrogen gas can be injected into the cavity through a needle inserted through the inflation hole. After pressing, an inert gas sealing layer is formed between the sealing ring and the edging ring.

The inert gas can protect the sealing ring and slow down the aging time of the sealing ring, further improving the sealing life. At the same time, nitrogen gas can enter through the guide grooves on both sides of the strip groove, and the gas pressure can press against the surface of the sealing strip, enhancing the tight contact between the sealing strip and the catalytic sheet and sealing film, improving the sealing performance, and preventing the aging of the sealing strip.

### BRIEF DESCRIPTION OF THE DRAWINGS

FIG. 1 is a schematic of the overall structure of the present invention;

FIG. 2 is an exploded view of the structure of the present invention;

FIG. 3 is an enlarged schematic view of the structure at location A in Image 2;

FIG. 4 is a partial sectional schematic view of the structure of the anode plate and cathode plate in FIG. 1;

FIG. 5 is an enlarged schematic view of the structure at location B in FIG. 4;

FIG. 6 is an enlarged schematic view of the structure at location C in FIG. 4;

FIG. 7 is a schematic diagram of the folded state of the edging ring structure in FIG. 6.

In the figure: 1, anode plate; 2. cathode plate; 3. through-hole; 4. sealing groove assembly; 41. first annular groove; 42. strip groove; 43. second annular groove; 5. diffusion sheet; 6. sealing ring; 7. edging ring; 71. ring body; 72. inflation hole; 8. sealing strip; 9. proton exchange membrane; 91. membrane electrode; 92. catalytic sheet; 93. sealing film; 10. cover.

### DETAILED DESCRIPTION OF THE EMBODIMENTS

The specific embodiments provided by the present invention are described in detail below in conjunction with the accompanying drawings.

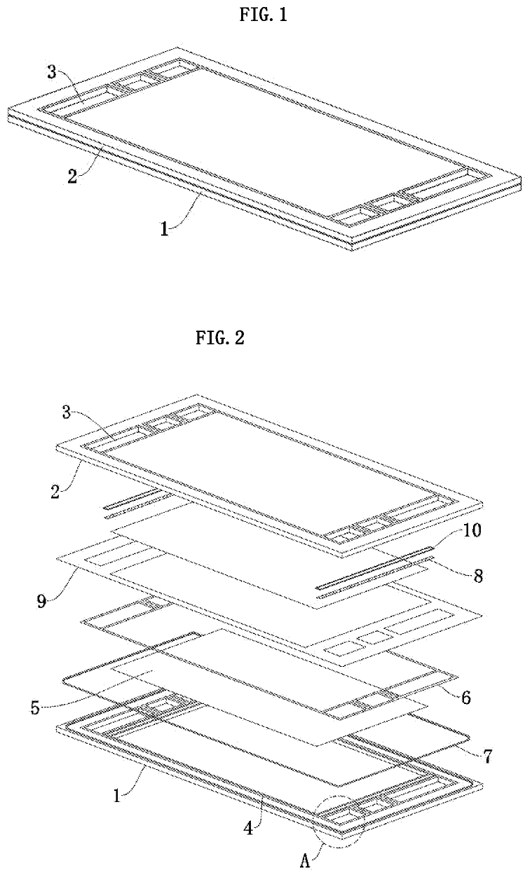

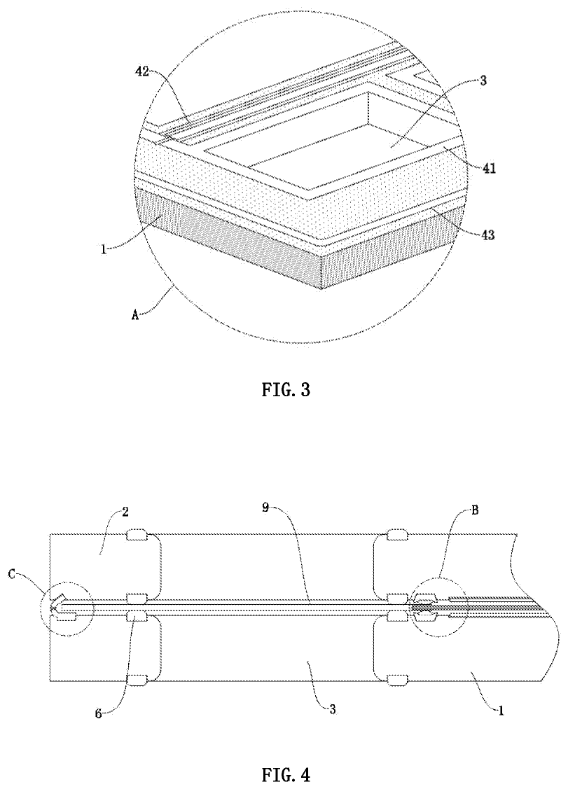

The present invention will be described in detail in the following in connection with the accompanying FIGS. 1 to 7 to provide a clear and complete description of the technical solutions in the embodiments of the present invention. Obviously, the described embodiments are only a part of the embodiments of the present invention, and not all of them. Based on the embodiments in the present invention, all other embodiments obtained by a person of ordinary skill in the art without making creative labor fall within the scope of protection of the present invention.

Please refer to FIGS. 1-7 for a sealing structure of a long-life membrane electrode sealing structure for a fuel cell provided in an embodiment of the present invention. The structure includes an anode plate 1 and a cathode plate 2 which are stacked together, and a proton exchange membrane 9 and two diffusion sheets 5 are sandwiched between the anode plate 1 and the cathode plate 2. The two diffusion sheets 5 are distributed on both sides of the proton exchange membrane 9. Both ends of the anode plate 1 and the cathode plate 2 are provided with through holes 3 for the intake and drainage.

The outer surface of the anode plate 1 is provided with a sealing groove assembly 4, which includes a first annular groove 41, a strip groove 42, and a second annular groove 43. The first annular groove 41 is embedded with a sealing ring 6, the interior of the strip groove 42 is stepped, and both sides of the strip groove 42 are provided with guide grooves that extend outwardly to the surface of the anode plate 1. The strip groove 42 is embedded with a sealing strip 8, and the outer surface of the sealing strip 8 is covered with a cover 10, which is embedded in the strip groove 42. The second annular groove 43 is fitted with an edging ring 7, which surrounds the sealing ring 6. The two ends of the sealing strip 8 are raised while the middle is recessed, and the center of the sealing strip 8 is integrally connected with a curved surface protrusion.

Furthermore, as shown in FIGS. 2 and 4, the sealing ring 6 is annular and surrounds the inner side of the anode plate 1, and the two ends of the sealing ring 6 are set around the outside of the through hole 3, so that the surrounding of the through hole 3 can also be sealed to form a fully enclosed sealing effect.

As shown in FIG. 4, there are two sealing rings 6 and sealing strips 8, respectively installed on the anode plate 1 and the cathode plate 2. When the anode plate 1 and the cathode plate 2 are stacked together, the two sealing rings 6 and sealing strips 8 can overlap to form a wrapped seal.

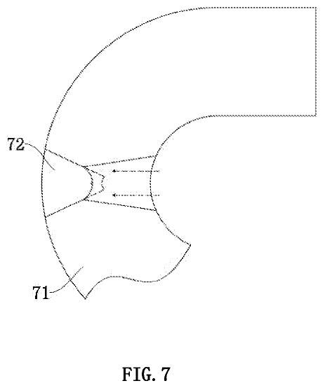

As shown in FIGS. 6-7, the edging ring 7 includes a ring body 71 and an inflation hole 72. The edge of the ring body 71 is arc-shaped, and the surface of the ring body 71 is provided with an inflation hole 72. As shown in FIGS. 6-7, the inflation hole 72 is combined by two trumpet-shaped through holes, and the right trumpet-shaped through hole is fitted at the tail end of the left trumpet-shaped through hole. After the ring body 71 is pressed and folded, the internal gas is discharged outwardly, pushing the edge of the inflation hole 72 to curl and block the exhaust hole to prevent air leakage.

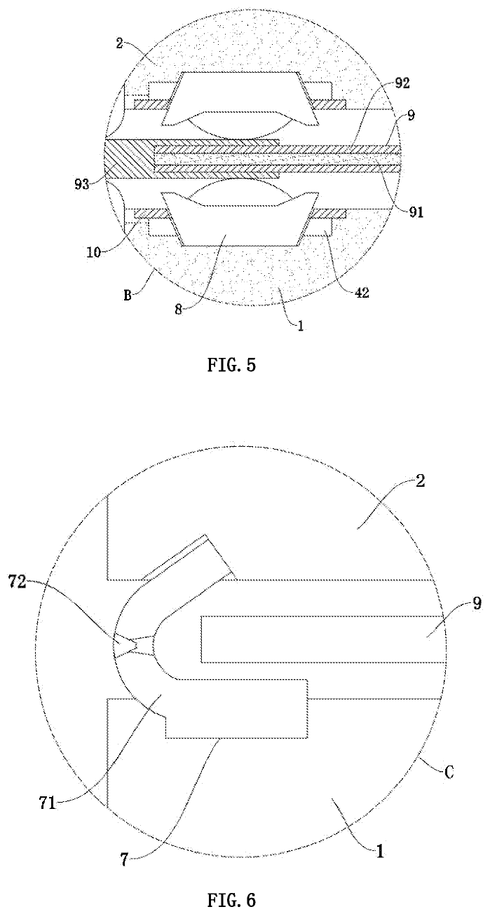

As shown in FIGS. 4-5, the proton exchange membrane 9 includes a membrane electrode 91, and the two sides of the membrane electrode 91 are attached with catalytic sheets 92. The outer periphery of the catalytic sheet 92 is wrapped with a sealing film 93, which is fixedly bonded to the catalytic sheet 92 by an adhesive, improving the sealing performance of the connection between the membrane electrode 91 and the catalytic sheet 92 and facilitating the later assembly.

In operation, the sealing strip 8 is inserted into the strip groove 42, and the sealing ring 6 and the edging ring 7 are respectively embedded in the first annular groove 41 and the second annular groove 43. Then, the two diffusion sheets 5 are sandwiched with the proton exchange membrane 9 and stacked in the anode plate 1. Finally, the cathode plate 2 is stacked on the anode plate 1.

After the anode plate 1 and the cathode plate 2 are stacked together, the sealing strip 8 is clamped at the junction of the catalytic sheet 92 and the sealing film 93. Through the pressing of the anode plate 1 and the cathode plate 2, the curved surface protrusion in the center of the sealing strip 8 is deformed and expanded to both sides, and the raised parts of the sealing strip 8 on both sides are adsorbed on the surface of the catalytic sheet 92 and the sealing film 93. The inclined surfaces on both sides of the sealing strip 8 can buffer the impact of the liquid, ensuring the stability of the seal even in a vehicle that is driven at high speeds for long periods of time.

The ring body 71 is bent inward, forming a cavity between the sealing ring 6. Nitrogen can be injected into the cavity through a needle passing through the inflation hole 72. Then, the anode plate 1 and the cathode plate 2 are pressed tightly, and during the compression process, the gas is discharged outwardly, pushing the inflation hole 72 to fold up and close the hole to prevent air leakage. This forms an inert gas sealing layer between the sealing ring 6 and the edging ring 7, which can protect the sealing ring 6 and slow down its aging time, thereby improving the sealing life. At the same time, nitrogen enters the second annular groove 43 through the guide groove, and the air pressure presses against the surface of the sealing strip 8, strengthening the tight contact between the sealing strip 8 and the catalytic sheet 92 and the sealing film 93, improving the sealing performance and preventing the aging of the sealing strip 8.

It is apparent to those skilled in the art that the present invention is not limited to the details of the exemplary embodiments described above, and that it is capable of being realized in other specific forms without departing from the spirit or essential features of the invention. Therefore, the embodiments should be regarded as exemplary and non-limiting from either point of view, and the scope of the present invention is limited by the appended claims and not by the above description, and therefore is intended to encapsulate all variations falling within the meaning and scope of the equivalent elements of the claims. Any appended markings in the claims should not be considered as limiting the claims involved.

1. A long-life membrane electrode sealing structure for a fuel cell, including an anode plate and a cathode plate the anode plate and cathode plate are stacked together and sandwich a proton exchange membrane and diffusion sheets between them; the diffusion sheets consist of two pieces and are distributed on both sides of the proton exchange membrane; the two ends of the anode plate and cathode plate are both provided with through holes, and the outer surface of the anode plate is provided with a sealing groove assembly, the sealing groove assembly includes a first annular groove, a strip groove, and a second annular groove; the first annular groove is embedded with a sealing ring, and the interior of the strip groove is stepped; both sides of the strip groove are provided with guide grooves that extend outward to the surface of the anode plate; the strip groove is embedded with a sealing strip, and the outer surface of the sealing strip is fitted with a cover; the cover is embedded in the strip groove; the second annular groove is embedded with an edging ring, and the edging ring surrounds the sealing ring; the two ends of the sealing strip are raised and the middle is depressed, and the center of the sealing strip is integrally connected with a cambered convex strip; wherein the number of sealing rings and sealing strips is two, and the two sealing rings and two sealing strips are respectively installed on the anode plate and cathode plate; wherein the edging ring includes a ring body and an inflation hole; the edge of the ring body is arc-shaped, and the surface of the ring body is provided with the inflation hole; the ring body bends inwardly, forming a cavity between the ring body and the sealing ring; the proton exchange membrane includes a membrane electrode; both sides of the membrane electrode are attached with catalytic sheets; the outer periphery of the catalytic sheets is wrapped with a sealing film; the sealing film is fixed to the catalytic sheets by an adhesive; after the anode plate and cathode plate are stacked, the sealing strip is clamped at a connection of the catalytic sheets and the sealing film; by pressing the anode plate and cathode plate the cambered convex strip at the center of the sealing strip deforms and expands towards both sides, causing lifted ends of the sealing strip to open and adhere to surfaces of the catalytic sheets and the sealing film, and sloping surfaces on both sides of the sealing strip can cushion an impact of liquid.

2. The long-life membrane electrode sealing structure for a fuel cell according to claim 1, wherein the sealing ring is annular and surrounds the inside of the anode plate in a circle, and the two ends of the sealing ring are set around the outside of the through holes.

3. The long-life membrane electrode sealing structure for a fuel cell according to claim 1, wherein the inflation hole is composed of two trumpet-shaped through-holes combined together, and a right trumpet-shaped through-hole is fitted on a tail end of a left trumpet-shaped through-hole.
